(19) United States
(12) Patent Application Publication
(10) Pub. No.: US 2022/0358058 A1
(43) Pub. Date: Nov. 10, 2022

(54) SIDEBAND SIGNAL ADJUSTMENT SYSTEM AND METHOD THEREOF

(71) Applicant: SILICON MOTION, INC., Zhubei City (TW)

(72) Inventors: Hung-Lian LIEN, Zhubei City (TW); Tsai-Fa LIU, Zhubei City (TW)

(73) Assignee: SILICON MOTION, INC., Zhubei City, (TW)

(21) Appl. No.: 17/385,922

(22) Filed: Jul. 27, 2021

(30) Foreign Application Priority Data
May 7, 2021 (TW) 110116646

(51) Int. Cl. G06F 13/16; G06F 1/26

(52) U.S. Cl. CPC G06F 13/1668; G06F 1/266

(57) ABSTRACT

Disclosed is a sideband signal adjustment system including an M.2 interface module containing a first power supply voltage pin and a second power supply voltage pin, a switching module, and a control module. When the control module detects that the second power pin receives a second power voltage, the switching module electrically connects to the second power supply voltage pin, and the control module receives or sends a second sideband signal with the same voltage level as the second power supply voltage through the M.2 interface module. When the control module detects that the first power supply voltage pin receives the first power supply voltage different from the second power voltage, the switching module electrically connects to the first power supply voltage pin, and the control module receives or sends a first sideband signal with the same voltage level as the first power supply voltage through the M.2 interface module.

### CROSS REFERENCE TO RELATED APPLICATION

This application claims the priority benefit of Taiwanese Patent Application Serial Number 110116646, filed on May 7, 2021, the full disclosure of which is incorporated herein by reference.

### BACKGROUND

### Technical Field

The present application relates to the technical field of M.2 interface, particularly to a sideband signal adjustment system and a method thereof.

### Related Art

The M.2 interface is a new transmission interface standard specification developed by the PCI-SIG and SATA-IO standard organizations. The M.2 interface has the characteristics of fast access speed, small size, and support for multiple interface protocols, so that the M.2 interface widely is used in various terminal equipments, such as solid-state drives (SSDs) and wireless gateways.

In the prior art, when the M.2 interface is used for high-speed communication between a device and a host (e.g., an information processing device such as a personal computer, a tablet computer, or other devices), the host and the device can receive and/or send a sideband signal with a voltage level of 3.3V through the M.2 interface.

However, in order to achieve the purpose of saving energy or diversified applications, the voltage level of the sideband signal between the host and the device may be adjusted, such as reducing the voltage level and reducing the current for power saving, so that the sideband signals for communication between the host and the device through the M.2 interface may have different voltage levels.

Therefore, how to enable the device with the M.2 interface to receive or send the sideband signals with different voltage levels and ensure the smooth operation is the goal of relevant industry.

### SUMMARY

The embodiments of the present application provide a sideband signal adjustment system and a method thereof, to enable a device such as a storage device with an M.2 interface to receive or send the sideband signals with different voltage levels, and ensure the smooth operation.

In a first aspect of the present application, there is provided a sideband signal adjustment system comprising an M.2 interface module, a switching module and a control module. The M.2 interface module comprises a first power supply voltage pin and a second power supply voltage pin. One end of the switching module is selectively electrically connected to the first power supply voltage pin or the second power supply voltage pin. The control module is electrically connected to the M.2 interface module and the other end of the switching module, and comprises a detection terminal and an input/output terminal. The detection terminal is configured to send a control signal to the switching module when detecting that the second power supply voltage pin receives a second power supply voltage, so that the switching module is electrically connected to the second power supply voltage pin; and to send another control signal to the switching module when detecting that the first power supply voltage pin receives a first power supply voltage, so that the switching module is electrically connected to the first power supply voltage pin, wherein the first power supply voltage and the second power supply voltage are different. The input/output terminal is configured to receive or send a second sideband signal with the same voltage level as the second power supply voltage through the M.2 interface module when the switching module is electrically connected to the second power supply voltage pin; and to receive or send a first sideband signal with the same voltage level as the first power supply voltage through the M.2 interface module when the switching module is electrically connected to the first power supply voltage pin.

In a second aspect of the present application, there is provided another sideband signal adjustment system comprising an M.2 interface module, a control module and a power management module. The M.2 interface module comprises a first power supply voltage pin and a second power supply voltage pin. The control module is electrically connected to the M.2 interface module, and comprises an input/output terminal. The power management module is electrically connected to the control module, the first power supply voltage pin, and the second power supply voltage pin, and is configured to provide a second power supply voltage to the control module when detecting that the second power supply voltage pin receives the second power supply voltage, so that the input/output terminal receives or sends a second sideband signal through the M.2 interface module; and to provide a first power supply voltage to the control module when detecting that the first power supply voltage pin receives the first power supply voltage, so that the input/output terminal receives or sends a first sideband signal through the M.2 interface module, wherein a voltage level of the first sideband signal is the same as that of the first power supply voltage, a voltage level of the second sideband signal is the same as that of the second power supply voltage, and the first power supply voltage is different from the second power supply voltage.

In a third aspect of the present application, there is provided a sideband signal adjustment method, comprising the following steps: providing a sideband signal adjustment system, which comprises an M.2 interface module, a switching module, and a control module, wherein the M.2 interface module comprises a first power supply voltage pin and a second power supply voltage pin, one end of the switching module is selectively electrically connected to the first power supply voltage pin or the second power supply voltage pin, and the control module is electrically connected to the M.2 interface module and the other end of the switching module; detecting, by the control module, whether the second power supply voltage pin receives a second power supply voltage, and whether the first power supply voltage pin receives a first power supply voltage, wherein the first power supply voltage and the second power supply voltage are different; sending, by the control module, a control signal to the switching module when detecting that the second power supply voltage pin receives the second power supply voltage, so that the switching module is electrically connected to the second power supply voltage pin; receiving or sending, by the control module, a second sideband signal through the M.2 interface module when the switching module being electrically connected to the second power supply voltage pin, wherein a voltage level of the second sideband signal is the same as that of the second power supply voltage; sending, by the control module, another control signal to the switching module when detecting that the first power supply voltage pin receives the first power supply voltage, so that the switching module is electrically connected to the first power supply voltage pin; and receiving or sending, by the control module, a first sideband signal through the M.2 interface module when the switching module being electrically connected to the first power supply voltage pin, wherein a voltage level of the first sideband signal is the same as that of the first power supply voltage.

In a fourth aspect of the present application, there is provided another sideband signal adjustment method comprising the following steps: providing a sideband signal adjustment system, which comprises an M.2 interface module, a control module and a power management module, wherein the M.2 interface module comprises a first power supply voltage pin and a second power supply voltage pin, the control module is electrically connected to the M.2 interface module, and the power management module is electrically connected to the control module, the first power supply voltage pin and the second power supply voltage pin; detecting, by the power management module, whether the second power supply voltage pin receives a second power supply voltage, and whether the first power supply voltage pin receives a first power supply voltage, wherein the first power supply voltage and the second power supply voltage are different; providing, by the power management module, the second power supply voltage to the control module when detecting that the second power supply voltage pin receives the second power supply voltage, so that the control module receives or sends a second sideband signal through the M.2 interface module, wherein a voltage level of the second sideband signal is the same as that of the second power supply voltage; and providing, by the power management module, the first power supply voltage to the control module when detecting that the first power supply voltage pin receives the first power supply voltage, so that the control module receives or sends a first sideband signal through the M.2 interface module, wherein a voltage level of the first sideband signal is the same as that of the first power supply voltage.

In the embodiments of the present application, by the setting of the switching module or the power management module, the sideband signal adjustment system and the method thereof can receive or send the second sideband signal with the same voltage level as the second power supply voltage since the second power supply voltage pin receives the second power supply voltage; and can receive or send the first sideband signal with the same voltage level as the first power supply voltage since the first power supply voltage pin receives the first power supply voltage. Therefore, a device with an M.2 interface, such as a storage device, that applies the sideband signal adjustment system can receive or send sideband signals with different voltage levels and ensure the smooth operation.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The FIGS. are for illustration purposes only and are not drawn to scale. The exemplary embodiments, both as to organization and method of operation, may best be understood by reference to the detailed description which follows taken in conjunction with the accompanying drawings in which:

FIG. 1 is a block diagram of an embodiment of a storage device applying a sideband signal adjustment system of the present application and a host;

FIG. 2 is a schematic diagram of a sideband signal adjustment system according to an embodiment of the present application;

FIG. 3 is a schematic diagram of a sideband signal adjustment system according to another embodiment of the present application;

FIG. 4 is a block diagram of another embodiment of a storage device applying a sideband signal adjustment system of the present application and a host;

FIG. 5 is a method flowchart of a sideband signal adjustment method according to an embodiment of the present application; and

FIG. 6 is a method flowchart of a sideband signal adjustment method according to another embodiment of the present application.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals are used to refer to the same or similar elements throughout the disclosure.

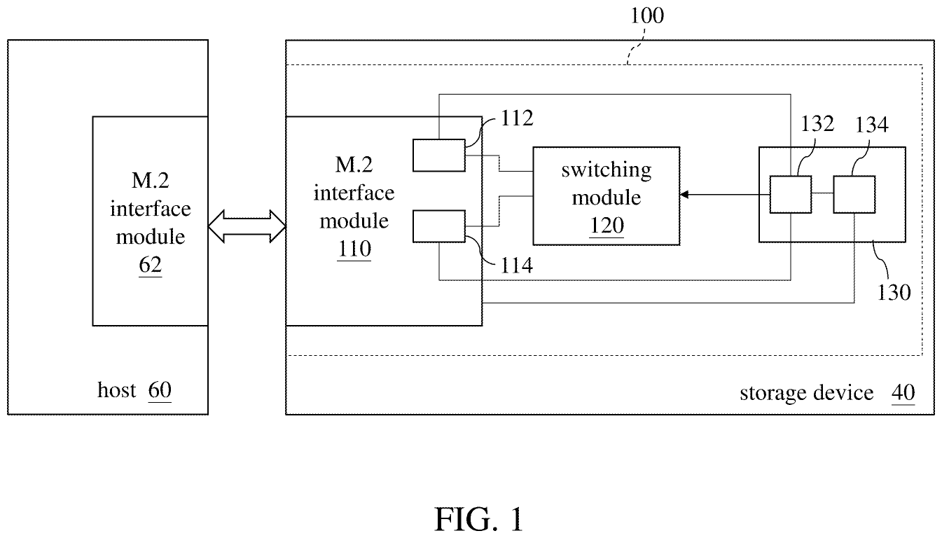

Please refer to FIG. 1, which is a block diagram of an embodiment of a storage device applying a sideband signal adjustment system of the present application and a host. As shown in FIG. 1, in this embodiment, the sideband signal adjustment system 100 can be applied to the storage device 40. The sideband signal adjustment system 100 comprises an M.2 interface module 110, a switching module 120, and a control module 130. The M.2 interface module 110 is configured to selectively connect to the M.2 interface module 62 of the host 60. In this embodiment, the storage device 40 may be, but not limited to, a solid state drive, the host 60 may be, but not limited to, a computer device, the M.2 interface module 110 may be, but not limited to, an M.2 interface connector, and the M.2 interface module 62 may be, but not limited to, a golden finger module conforming to the M.2 interface standard specification, but this embodiment is not intended to limit the application, and can be adjusted according to actual needs.

In this embodiment, the M.2 interface module 110 comprises a first power supply voltage pin 112 and a second power supply voltage pin 114. The first power supply voltage pin 112 is configured to receive a first power supply voltage, the second power supply voltage pin 112 is configured to receive a second power supply voltage, and the first power supply voltage is different from the second power supply voltage. Specifically, when the M.2 interface module 110 is connected to the M.2 interface module 62, the first power supply voltage pin 112 can receive the first power supply voltage if the host 60 provides the first power supply voltage to the first power supply voltage pin 112 through the M.2 interface module 62; and the second power supply voltage pin 114 can receive the second power supply voltage if the host 60 provides the second power supply voltage to the second power supply voltage pin 114 through the M.2 interface module 62. The type of the M.2 interface module 110 can be, but is not limited to, B-KEY (Socket 2), the M.2 interface module 62 has a corresponding structure conforming to the B-KEY, but this embodiment is not intended to limit the application, and can be adjusted according to actual needs. In one embodiment, the type of the M.2 interface module 110 can be, but is not limited to, M-KEY (Socket 3), and the M.2 interface module 62 has a corresponding structure conforming to the M-KEY. In another embodiment, the M.2 interface module 110 includes a circuit compatible with B-KEY and M-KEY, and the M.2 interface module 62 may have a corresponding structure conforming to the M-KEY or the B-KEY.

In this embodiment, the first power supply voltage pin 112 may be, but not limited to, pin 72 (that is, pin 72 in the current M.2 interface standard specification), and the second power supply voltage pin 114 may be, but not limited to, pin 22 (that is, pin 22 in the current M.2 interface standard specification), the voltage level of the first power supply voltage is 3.3V, and the voltage level of the second power supply voltage is 1.8V, but this embodiment is not intended to limit the application, and can be adjusted according to actual needs. For example, the second power supply voltage pin 114 can be any undefined pin in the current M.2 interface standard specification.

In this embodiment, one end of the switching module 120 is selectively electrically connected to the first power supply voltage pin 112 or the second power supply voltage pin 114, and the control module 130 is electrically connected to the M.2 interface module 110 and the other end of the switching module 120, and includes a detection terminal 132 and an input/output terminal 134.

The detection terminal 132 is electrically connected to the M.2 interface module 110 and the switching module 120, and is configured to send a control signal to the switching module 120 when detecting that the second power supply voltage pin 114 receives the second power supply voltage, so that the switching module 120 is electrically connected to the second power supply voltage pin 114; and to send another control signal to the switching module 120 when detecting that the first power supply voltage pin 112 receives the first power supply voltage, so that the switching module 120 is electrically connected to the first power supply voltage pin 112. In other words, the detection terminal 132 can be configured to detect whether the second power supply voltage pin 114 receives the second power supply voltage and whether the first power supply voltage pin 112 receives the first power supply voltage to output the corresponding control signal to the switching module 120 to switch the connection relationship.

In one embodiment, the detection terminal 132 is further configured to send another control signal to the switching module 120 when detecting that the second power supply voltage pin 114 does not receive the second power supply voltage and the first power supply voltage pin 112 receives the first power supply voltage, so that the switching module 120 is electrically connected to the first power supply voltage pin 112.

In this embodiment, the input/output terminal 134 is electrically connected to the M.2 interface module 110 and the detection terminal 132, and is configured to receive or send a second sideband signal with the same voltage level as the second power supply voltage through the M.2 interface module 110 when the switching module 120 is electrically connected to the second power supply voltage pin 114; and to receive or send a first sideband signal with the same voltage level as the first power supply voltage through the M.2 interface module 110 when the switching module 120 is electrically connected to the first power supply voltage pin 112. In other words, the input/output terminal 134 can receive or send the second sideband signal with the same voltage level as the second power supply voltage through the M.2 interface module 110 since the second power supply voltage pin 114 receives the second power supply voltage, and the input/output terminal 134 can receive or send the first sideband signal with the same voltage level as the first power supply voltage through the M.2 interface module 110 since the first power supply voltage pin 112 receives the first power supply voltage. The number of the input/output terminal 134 can be, but not limited to, one, and the pin of the M.2 interface module 110 to which the input/output terminal 134 is connected can be, but is not limited to, pin 50 (that is, PERST#), pin 52 (that is, CLKREQ#) and/or pin 54 (that is, PEWAKE#) in the current M.2 interface standard specification.

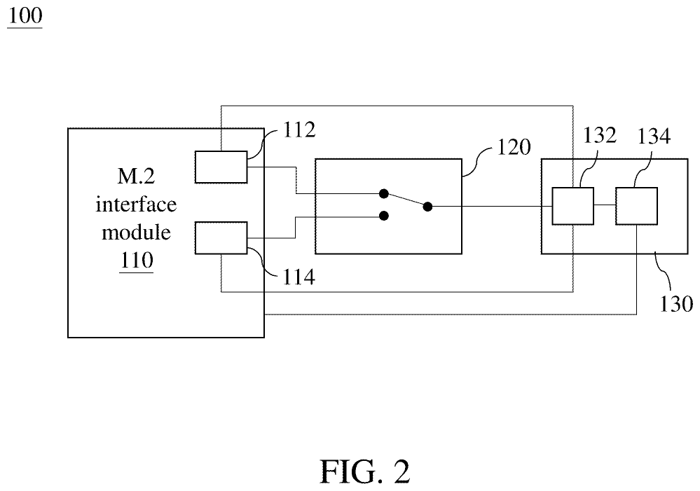

In an embodiment, please refer to FIG. 2, which is a schematic diagram of a sideband signal adjustment system according to an embodiment of the present application. In this embodiment, the switching module 120 consists of a single pole double throw (SPDT) circuit. Specifically, one end of the SPDT circuit is connected to the control module 130, and the other end of the SPDT circuit is respectively physically connected to the first power supply voltage pin 112 and the second power supply voltage pin 114. When the SPDT circuit receives the control signal, the SPDT circuit is electrically connected to the second power supply voltage pin 114. When the SPDT circuit receives the another control signal, the SPDT circuit is electrically connected to the first power supply voltage pin 112.

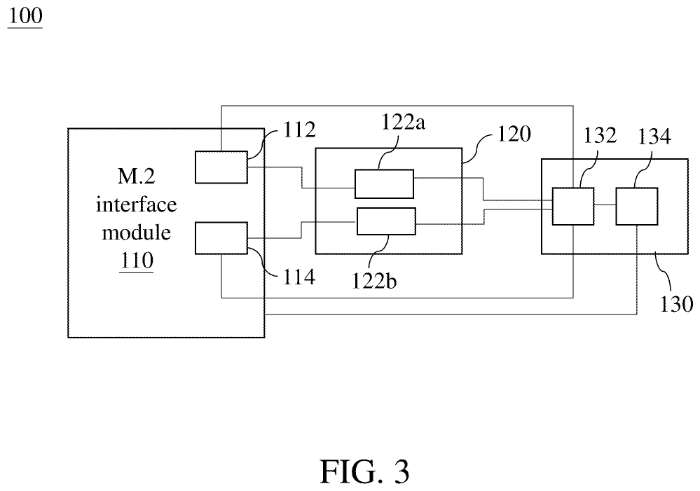

In another embodiment, please refer to FIG. 3, which is a schematic diagram of a sideband signal adjustment system according to another embodiment of the present application. In this embodiment, the switching module 120 comprises a switch 122a and a switch 122b. One end of the switch 122a is connected to the first power supply voltage pin 112, and the other end of the switch 122a is connected to the control module 130. One end of the switch 122b is connected to the second power supply pin 114, and the other end of the switch 122b is connected to the control module 130. Specifically, the switching module 120 can turn on or turn off the switch 122a and the switch 122b based on the control signal from the control module 130. When detecting that the second power supply voltage pin 114 receives the second power supply voltage, the control module 130 sends a control signal to the switching module 120, so that the switching module 120 turns on the switch 122b and turns off the switch 122a based on the control signal, thereby the switching module 120 electrically connecting to the second power supply voltage pin 114. When detecting that the first power supply voltage pin 112 receives the first power supply voltage, the control module 130 sends another control signal to the switching module 120, so that the switching module 120 turns on the switch 122a and turns off the switch 122b based on the another control signal, thereby the switching module 120 electrically connecting to the first power supply voltage pin 112. The switch 122a and the switch 122b can be but not limited to transistors.

In one embodiment, when detecting that the second power supply voltage pin 114 does not receive the second power supply voltage and the first power supply voltage pin 112 receives the first power supply voltage, the control module 130 sends another control signal to the switching module 120, so that the switching module 120 turns on the switch 122a and turns off the switch 122b based on the another control signal, thereby the switching module 120 electrically connecting to the first power supply voltage pin 112.

In one embodiment, the switching module 120 and the control module 130 are integrated together.

In an embodiment, the control module 130 may be, but is not limited to, a system-on-chip (SoC).

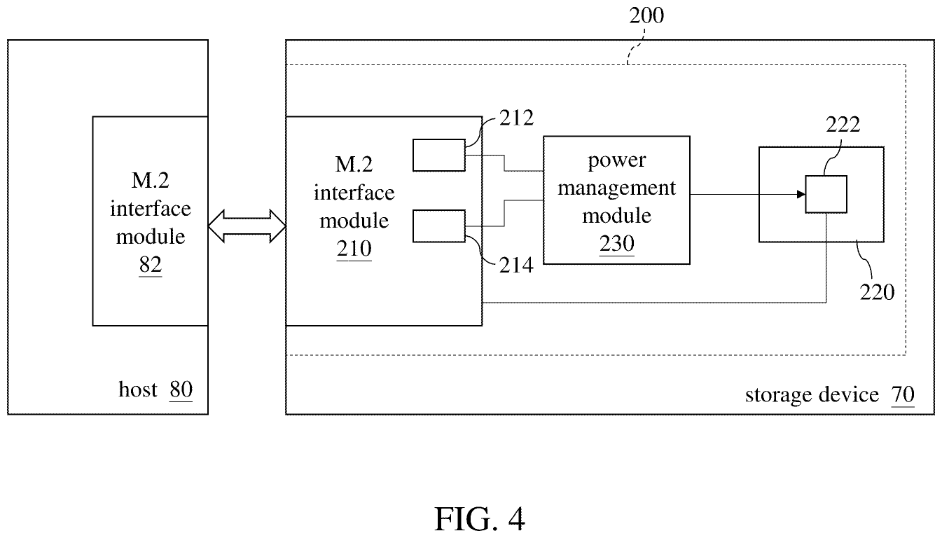

Please refer to FIG. 4, which is a block diagram of another embodiment of a storage device applying a sideband signal adjustment system of the present application and a host. As shown in FIG. 4, in this embodiment, the sideband signal adjustment system 200 can be applied to the storage device 70. The sideband signal adjustment system 200 comprises an M.2 interface module 210, a control module 220, and a power management module 230. The M.2 interface module 210 is configured to selectively connect to the M.2 interface module 82 of the host 80. In this embodiment, the storage device 70 may be, but not limited to, a solid state drive, the host 80 may be, but not limited to, a computer device, and the M.2 interface module 210 may be, but not limited to, an M.2 interface connector, and the M.2 interface module 82 can be, but is not limited to, a golden finger module conforming to the M.2 interface standard specification, but this embodiment is not intended to limit the application, and can be adjusted according to actual needs.

In this embodiment, the M.2 interface module 210 comprises a first power supply voltage pin 212 and a second power supply voltage pin 214. The first power supply voltage pin 212 is configured to receive the first power supply voltage, the second power supply voltage pin 214 is configured to receive the second power supply voltage, and the first power supply voltage is different from the second power supply voltage. Specifically, when the M.2 interface module 210 is connected to the M.2 interface module 82, the first power supply voltage pin 212 can receive the first power supply voltage if the host 80 provides the first power supply voltage to the first power supply voltage pin 212 through the M.2 interface module 82; and the second power supply voltage pin 214 can receive the second power supply voltage if the host 80 provides the second power supply voltage to the second power supply voltage pin 214 through the M.2 interface module 82. The type of the M.2 interface module 210 can be B-KEY(Socket 2) or M-KEY(Socket 3), or the M.2 interface module 210 comprises a circuit compatible with the B-KEY and the M-KEY.

In this embodiment, the first power supply voltage pin 212 may be, but not limited to, pin 72 (that is, pin 72 in the current M.2 interface standard specification), and the second power supply voltage pin 214 may be, but not limited to, pin 22 (that is, pin 22 in the current M.2 interface standard specification), the voltage level of the first power supply voltage is 3.3V, and the voltage level of the second power supply voltage is 1.8V, but this embodiment is not intended to limit the application, and can be adjusted according to actual needs. For example, the second power supply voltage pin 214 can be any undefined pin in the current M.2 interface standard specification.

In this embodiment, the control module 220 is electrically connected to the M.2 interface module 210 and comprises an input/output terminal 222. The power management module 230 is electrically connected to the control module 220, the first power supply voltage pin 212 and the second power supply voltage pin 214, and is configured to provide the second power supply voltage to the control module 220 when detecting that the second power supply voltage pin 214 receives the second power supply voltage, so that the input/output terminal 222 receives or sends a second sideband signal through the M.2 interface module 210; and to provide the first power supply voltage to the control module 220 when detecting that the first power supply voltage pin 212 receives the first power supply voltage, so that the input/output terminal 222 receives or sends a first sideband signal through the M.2 interface module 210. The voltage level of the first sideband signal is the same as that of the first power supply voltage, the voltage level of the second sideband signal is the same as that of the second power supply voltage, and the first power supply voltage is different from the second power supply voltage.

In other words, by the setting of the power management module 230, the input/output terminal 222 can receive or send the second sideband signal with the same voltage level as the the second power supply voltage through the M.2 interface module 210 since the second power supply voltage pin 214 receives the second power supply voltage; and the input/output terminal 222 can receive or send the first sideband signal with the same voltage level as the the first power supply voltage through the M.2 interface module 210 since the first power supply voltage pin 212 receives the first power supply voltage. The number of the input/output terminal 222 can be, but not limited to, one, and the pin of the M.2 interface module 210 connected to the input/output terminal 222 can be, but is not limited to, pin 50 (that is, PERST#), pin 52 (that is, CLKREQ#) and/or pin 54 (that is, PEWAKE#) in the current M.2 interface standard specification.

In one embodiment, when detecting that the second power supply voltage pin 214 of the M.2 interface module 210 does not receive the second power supply voltage and the first power supply voltage pin 212 receives the first power supply voltage, the power management module 230 provides the first power supply voltage to the control module 220, so that the input/output terminal 222 receives or sends the first sideband signal through the M.2 interface module 210.

In an embodiment, the power management module 230 may be, but is not limited to, a power management integrated circuit (IC). The power management module 230 can receive a power voltage from the host 80 to perform voltage conversion on the received power voltage and output the converted power voltage to the controller of the storage device 70, except detects whether the second power supply voltage pin 214 receives the second power voltage, and whether the first power supply voltage pin 212 receives the first power supply voltage. For example, the power management module 230 can receive a power voltage of 12V and convert it into 3.3V, 1.2V, or 1.8V, and output the converted power voltage to the controller of the storage device 70.

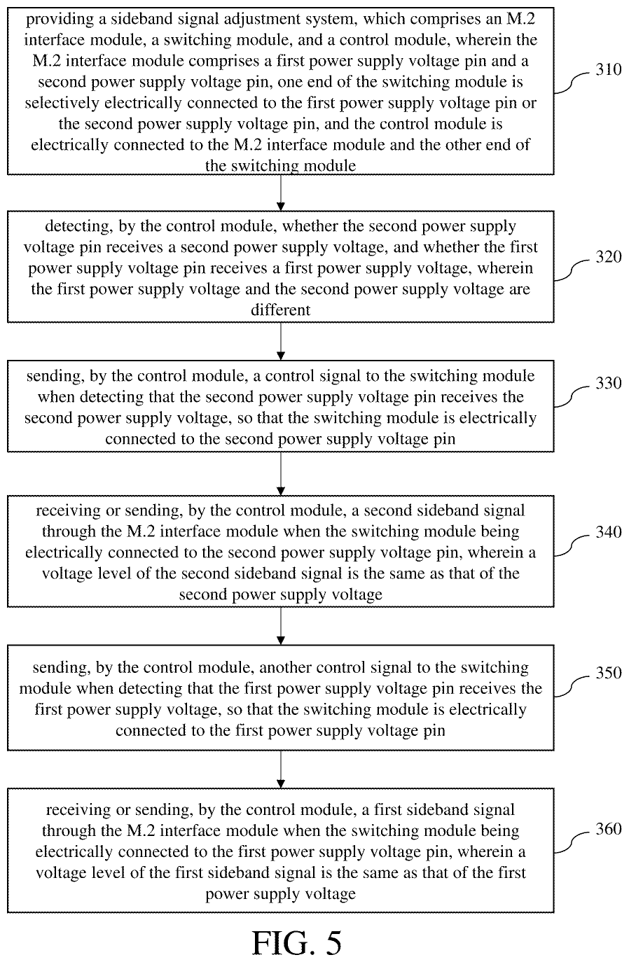

Please refer to FIG. 5, which is a method flowchart of a sideband signal adjustment method according to an embodiment of the present application. In this embodiment, the sideband signal adjustment method comprises the following steps: providing a sideband signal adjustment system, which comprises an M.2 interface module, a switching module, and a control module, wherein the M.2 interface module comprises a first power supply voltage pin and a second power supply voltage pin, one end of the switching module is selectively electrically connected to the first power supply voltage pin or the second power supply voltage pin, and the control module is electrically connected to the M.2 interface module and the other end of the switching module (step 310); detecting, by the control module, whether the second power supply voltage pin receives a second power supply voltage, and whether the first power supply voltage pin receives a first power supply voltage, wherein the first power supply voltage and the second power supply voltage are different (step 320); sending, by the control module, a control signal to the switching module when detecting that the second power supply voltage pin receives the second power supply voltage, so that the switching module is electrically connected to the second power supply voltage pin (step 330); receiving or sending, by the control module, a second sideband signal through the M.2 interface module when the switching module being electrically connected to the second power supply voltage pin, wherein a voltage level of the second sideband signal is the same as that of the second power supply voltage (step 340); sending, by the control module, another control signal to the switching module when detecting that the first power supply voltage pin receives the first power supply voltage, so that the switching module is electrically connected to the first power supply voltage pin (step 350); and receiving or sending, by the control module, a first sideband signal through the M.2 interface module when the switching module being electrically connected to the first power supply voltage pin, wherein a voltage level of the first sideband signal is the same as that of the first power supply voltage (step 360). The detailed description has been explained in the above paragraphs, and is not repeated here.

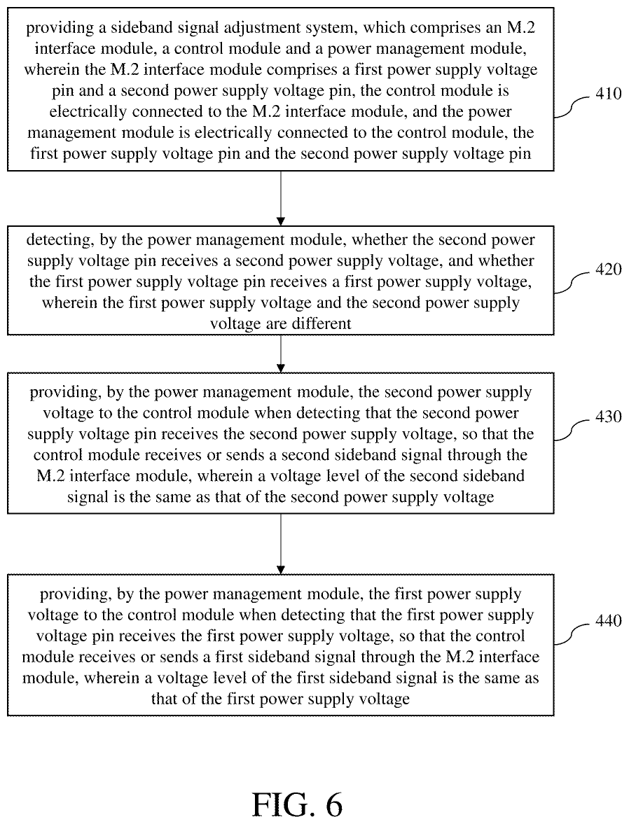

Please refer to FIG. 6, which is a method flowchart of a sideband signal adjustment method according to another embodiment of the present application. In this embodiment, the sideband signal adjustment method comprises the following steps: providing a sideband signal adjustment system, which comprises an M.2 interface module, a control module and a power management module, wherein the M.2 interface module comprises a first power supply voltage pin and a second power supply voltage pin, the control module is electrically connected to the M.2 interface module, and the power management module is electrically connected to the control module, the first power supply voltage pin and the second power supply voltage pin (step 410); detecting, by the power management module, whether the second power supply voltage pin receives a second power supply voltage, and whether the first power supply voltage pin receives a first power supply voltage, wherein the first power supply voltage and the second power supply voltage are different (step 420); providing, by the power management module, the second power supply voltage to the control module when detecting that the second power supply voltage pin receives the second power supply voltage, so that the control module receives or sends a second sideband signal through the M.2 interface module, wherein a voltage level of the second sideband signal is the same as that of the second power supply voltage (step 430); and providing, by the power management module, the first power supply voltage to the control module when detecting that the first power supply voltage pin receives the first power supply voltage, so that the control module receives or sends a first sideband signal through the M.2 interface module, wherein a voltage level of the first sideband signal is the same as that of the first power supply voltage (step 440). The detailed description has been explained in the above paragraphs, and is not repeated here.

In summary, by the setting of the switching module or the power management module, the sideband signal adjustment system and the method thereof of the embodiments of the present application can receive or send the second sideband signal with the same voltage level as the second power supply voltage since the second power supply voltage pin receives the second power supply voltage; and can receive or send the first sideband signal with the same voltage level as the first power supply voltage since the first power supply voltage pin receives the first power supply voltage. Therefore, a device with an M.2 interface, such as a storage device, that applies the sideband signal adjustment system can receive or send sideband signals with different voltage levels and ensure the smooth operation.

In addition, the switching module consisting of a single-pole double-throw circuit or including two switches has the characteristics of low cost and small size, so that when the switching module is applied to the device with M.2 interface, such as a storage device, it can meet the needs of the device with M.2 interface for light, thin, short and low cost.

It is to be understood that the term “comprises”, “comprising”, or any other variants thereof, is intended to encompass a non-exclusive inclusion, such that a process, method, article, or device of a series of elements not only comprise those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A sideband signal adjustment system, comprising:
an M.2 interface module including a first power supply voltage pin and a second power supply voltage pin;
a switching module, one end of the switching module being selectively electrically connected to the first power supply voltage pin or the second power supply voltage pin; and
a control module electrically connected to the M.2 interface module and the other end of the switching module, and comprising:
a detection terminal configured to send a control signal to the switching module when detecting that the second power supply voltage pin receives a second power supply voltage, so that the switching module is electrically connected to the second power supply voltage pin, and to send another control signal to the switching module when detecting that the first power supply voltage pin receives a first power supply voltage, so that the switching module is electrically connected to the first power supply voltage pin, wherein the first power supply voltage and the second power supply voltage are different; and
an input/output terminal electrically connected to the detection terminal, and configured to receive or send a second sideband signal with the same voltage level as the second power supply voltage through the M.2 interface module when the switching module is electrically connected to the second power supply voltage pin; and to receive or send a first sideband signal with the same voltage level as the first power supply voltage through the M.2 interface module when the switching module is electrically connected to the first power supply voltage pin.

2. The sideband signal adjustment system according to claim 1, wherein the switching module and the control module are integrated together.

3. The sideband signal adjustment system according to claim 1, wherein the switching module consists of a single pole double throw (SPDT) circuit.

4. The sideband signal adjustment system according to claim 1, wherein the M.2 interface module comprises a circuit compatible with B-KEY and M-KEY.

5. The sideband signal adjustment system according to claim 1, wherein the second power supply voltage pin is pin 22 in the M.2 interface standard specification.

6. The sideband signal adjustment system according to claim 1, wherein a voltage level of the first power supply voltage is 3.3 volts (V), and a voltage level of the second power supply voltage is 1.8V.

7. A sideband signal adjustment system, comprising:
an M.2 interface module including a first power supply voltage pin and a second power supply voltage pin;
a control module electrically connected to the M.2 interface module and including an input/output terminal; and
a power management module electrically connected to the control module, the first power supply voltage pin and the second power supply voltage pin, and configured to provide the second power supply voltage to the control module when detecting that the second power supply voltage pin receives a second power supply voltage, so that the input/output terminal receives or sends a second sideband signal through the M.2 interface module; and to provide the first power supply voltage to the control module when detecting that the first power supply voltage pin receives the first power supply voltage, so that the input/output terminal receives or sends a first sideband signal through the M.2 interface module;
wherein a voltage level of the first sideband signal is the same as that of the first power supply voltage, and a voltage level of the second sideband signal is the same as that of the second power supply voltage, and the first power supply voltage and the second power supply voltage are different.

8. The sideband signal adjustment system according to claim 7, wherein the second power supply voltage pin is pin 22 in the M.2 interface standard specification.

9. The sideband signal adjustment system according to claim 7, wherein a voltage level of the first power supply voltage is 3.3V, and a voltage level of the second power supply voltage is 1.8V.

10. A sideband signal adjustment method, comprising:
providing a sideband signal adjustment system, which comprises an M.2 interface module, a switching module, and a control module, wherein the M.2 interface module comprises a first power supply voltage pin and a second power supply voltage pin, one end of the switching module is selectively electrically connected to the first power supply voltage pin or the second power supply voltage pin, and the control module is electrically connected to the M.2 interface module and the other end of the switching module;
detecting, by the control module, whether the second power supply voltage pin receives a second power supply voltage, and whether the first power supply voltage pin receives a first power supply voltage, wherein the first power supply voltage and the second power supply voltage are different;
sending, by the control module, a control signal to the switching module when detecting that the second power supply voltage pin receives the second power supply voltage, so that the switching module is electrically connected to the second power supply voltage pin;
receiving or sending, by the control module, a second sideband signal through the M.2 interface module when the switching module being electrically connected to the second power supply voltage pin, wherein a voltage level of the second sideband signal is the same as that of the second power supply voltage;
sending, by the control module, another control signal to the switching module when detecting that the first power supply voltage pin receives the first power supply voltage, so that the switching module is electrically connected to the first power supply voltage pin; and
receiving or sending, by the control module, a first sideband signal through the M.2 interface module when the switching module being electrically connected to the first power supply voltage pin, wherein a voltage level of the first sideband signal is the same as that of the first power supply voltage.

11. A sideband signal adjustment method, comprising:
providing a sideband signal adjustment system, which comprises an M.2 interface module, a control module and a power management module, wherein the M.2 interface module comprises a first power supply voltage pin and a second power supply voltage pin, the control module is electrically connected to the M.2 interface module, and the power management module is electrically connected to the control module, the first power supply voltage pin and the second power supply voltage pin;
detecting, by the power management module, whether the second power supply voltage pin receives a second power supply voltage, and whether the first power supply voltage pin receives a first power supply voltage, wherein the first power supply voltage and the second power supply voltage are different;
providing, by the power management module, the second power supply voltage to the control module when detecting that the second power supply voltage pin receives the second power supply voltage, so that the control module receives or sends a second sideband signal through the M.2 interface module, wherein a voltage level of the second sideband signal is the same as that of the second power supply voltage; and
providing, by the power management module, the first power supply voltage to the control module when detecting that the first power supply voltage pin receives the first power supply voltage, so that the control module receives or sends a first sideband signal through the M.2 interface module, wherein a voltage level of the first sideband signal is the same as that of the first power supply voltage.
